(19) United States
(12) Patent Application Publication
(10) Pub. No.: US 2014/0183249 A1
(43) Pub. Date: Jul. 3, 2014

(54) SUBSTRATE PROCESSING DEVICE AND METHOD OF MANUFACTURING THE SAME

(71) Applicant: Samsung Electro-Mechanics Co., Ltd., Suwon-si (KR)

(72) Inventors: Hyun Sik CHOI, Suwon-si (KR); Bong Yeol LEE, Suwon-si (KR); Min Hee YOON, Suwon-si (KR); Seung Chul KIM, Suwon-si (KR)

(73) Assignee: Samsung Electro-Mechanics Co., Ltd., Suwon-si (KR)

(21) Appl. No.: 14/143,389

(22) Filed: Dec. 30, 2013

(30) Foreign Application Priority Data
Dec. 31, 2012 (KR) 10-2012-0158174

(51) Int. Cl. B23K 1/20; B23K 3/06; B23K 3/08

(52) U.S. Cl. CPC B23K 1/203; B23K 3/082; B23K 3/0607
USPC 228/223; 228/33; 228/41

(57) ABSTRACT

Disclosed herein is a substrate processing device, including: a first mask disposed over a base substrate and provided with a first opening which exposes a connection pad of the base substrate; a first squeeze inserting a flux ball into a first opening of the first mask; and a first heating means heating a flux ball which is disposed on the connection pad.

### CROSS REFERENCE TO RELATED APPLICATION

This application claims the benefit of Korean Patent Application No. 10-2012-0158174, filed on Dec. 31, 2012, entitled “Substrate Processing Device And Method Of Manufacturing The same”, which is hereby incorporated by reference in its entirety into this application.

### BACKGROUND OF THE INVENTION

1. Technical Field

The present invention relates to a substrate processing device and a method of manufacturing the same.

2. Description of the Related Art

In general, a plurality of semiconductor chips are formed by performing various semiconductor processes on a semiconductor substrate. In order to mount each semiconductor chip on a printed circuit board, a semiconductor package is formed by performing a packaging process on the semiconductor chips.

The semiconductor package includes a package substrate, a semiconductor chip mounted on the package substrate, a conductive connection member which electrically connects the semiconductor chip to the package substrate, a molding member formed on the package substrate to cover the semiconductor chip, and external connection terminals mounted on the package substrate.

The conductive connection member includes a wire, a bump, and the like. The package having a structure in which the semiconductor chip is connected to the package substrate through the bump is a flip chip package. Prior to forming the bump on the package substrate, a process of applying a flux may be performed. The flux is to remove an oxide layer which is formed on the bump or the substrate (U.S. Pat. No. 6,598,779). The process of applying a flux may be classified into a method of applying the flux to the bump and a method of applying the flux to a connection pad of the package substrate. In this case, when the flux is excessively applied, a short between the fluxes applied to the adjacent connection pads may occur.

### SUMMARY OF THE INVENTION

The present invention has been made in an effort to provide a substrate processing device and a method of manufacturing the same capable of preventing a flux short or a bump short.

According to a preferred embodiment of the present invention, there is provided a substrate processing device, including: a first mask disposed over a base substrate and provided with a first opening which exposes a connection pad of the base substrate; a first squeeze inserting a flux ball into a first opening of the first mask; and a first heating means heating a flux ball which is disposed on the connection pad.

The flux ball may be in a solid state.

The first mask may be a metal mask.

The substrate processing device may further include: a second mask provided with a second opening disposed at a position corresponding to an upper portion of the connection pad.

A solder ball may be inserted into the second opening of the second mask.

The substrate processing device may further include: a second squeeze inserting the solder ball into the second opening of the second mask.

The substrate processing device may further include: a second heating means heating the solder ball.

According to another preferred embodiment of the present invention, there is provided a method of manufacturing a substrate, including: preparing a base substrate provided with a connection pad; forming a first mask including a first opening exposing the connection pad over the base substrate; inserting the flux ball into the first opening of the first mask; and heating the flux ball.

The flux ball may be in a solid state.

The first mask may be a metal mask.

In the inserting of the flux ball into the first opening of the first mask, the flux ball may be inserted into the first opening by using a first squeeze.

The method of manufacturing a substrate may further include: after the inserting of the flux ball into the first opening of the first mask, removing the first mask.

The method of manufacturing a substrate may further include: after the heating of the flux ball, disposing the solder ball over the heated flux ball.

The disposing of the solder ball may include: forming a second mask, which is provided with the second opening disposed at a position corresponding to an upper portion of the connection pad, over the base substrate; and inserting the solder ball into the second opening of the second mask.

In the inserting of the solder ball into the second opening of the second mask, the solder ball may be inserted into the second opening by using a second squeeze.

The method of manufacturing a substrate may further include: after the inserting of the solder ball into the second opening of the second mask, removing the second mask.

The method of manufacturing a substrate may further include: after the inserting of the solder ball into the second opening of the second mask, heating the solder ball to form a bump.

The method of manufacturing a substrate may further include: after the forming of the bump, removing a flux remaining on the base substrate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplified diagram illustrating a substrate processing device according to a preferred embodiment of the present invention;

FIG. 2 is an exemplified diagram illustrating a substrate processing device according to another preferred embodiment of the present invention; and

FIGS. 3 to 10 are exemplified diagrams illustrating a method of manufacturing a substrate according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

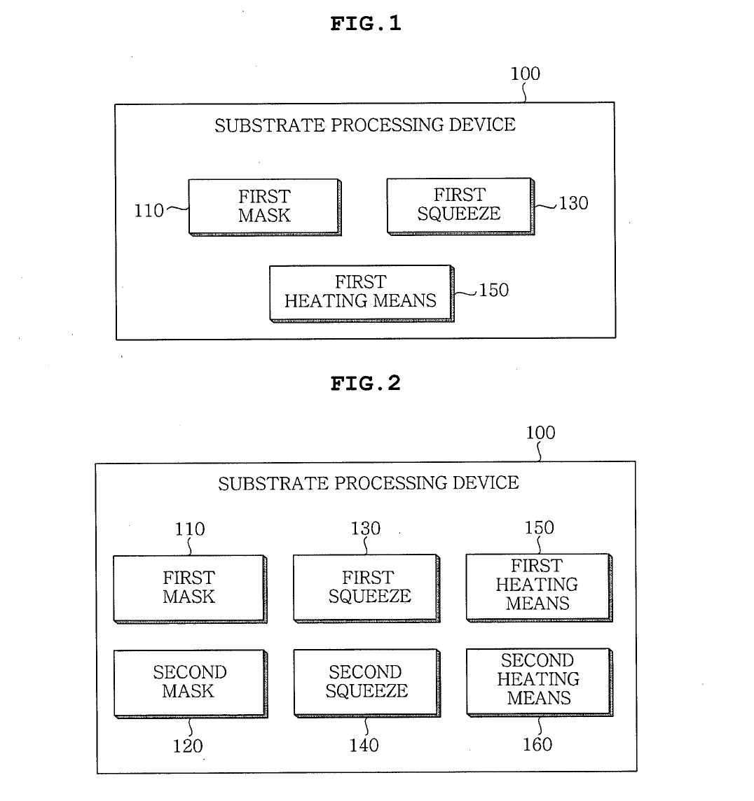

FIG. 1 is an exemplified diagram illustrating a substrate processing device according to a preferred embodiment of the present invention.

Referring to FIG. 1, a substrate processing device 100 may include a first mask 110, a first squeeze 130, and a first heating means 150.

According to the preferred embodiment of the present invention, the substrate processing device 100 is a device for applying a flux to a base substrate.

The first mask 110 may be positioned over the base substrate. The base substrate may include a connection pad. The connection pad is a region in which a bump is formed later and may be mounted with a flux ball. The flux ball may be in a solid state. For example, the flux ball may be a spherical solid particle which is formed of a flux. Further, the flux ball may be formed by including at least one of rosin, resin, a thinner, and an activator. The first mask 110 may be provided with a first opening which exposes the connection pad provided with the flux ball. The flux ball may be disposed on the connection pad through the first opening of the first mask 110. FIG. 1 illustrates that the first mask 110 is formed to contact the base substrate. However, the preferred embodiment of the present invention is not limited thereto. The first mask 110 may be disposed to be vertically spaced apart from the base substrate at a predetermined distance. As such, a disposition relationship between the first mask 110 and the base substrate may be easily changed by those skilled in the art.

The first squeeze 130 may insert the flux ball into the first opening of the first mask 110. The first squeeze 130 squeezes at least one flux ball over the first mask 110 to insert each of the flux balls into the first opening. The first squeeze 130 may be made of materials, such as metal and rubber.

The first heating means 150 may heat the flux ball. The first heating means 150 may include at least one heater. Further, the first heating means 150 may include a hot air heater. FIG. 1 illustrates that the first heating means 150 is disposed on the base substrate, but the preferred embodiment of the present invention is not limited thereto. The first heating means 150 may be disposed at any place where the flux ball mounted on the connection pad of the base substrate may be heated.

In the substrate processing device 100 According to the preferred embodiment of the present invention, a single spherical flux ball may be mounted on a single connection pad. As such, the flux ball is mounted on the connection pad and is then heated, such that the flux may be applied to the connection pad. In this case, since the single flux ball is mounted on each of the connection pads, the same amount of flux may be applied to all the connection pads.

Although not illustrated in the preferred embodiment of the present invention, the substrate processing device 100 may further include a flux ball pick-up device (not illustrated) which individually mounts the flux balls on the connection pad on which the flux ball is not mounted, after the flux ball is squeezed by the first squeeze 130.

FIG. 2 is an exemplified diagram illustrating a substrate processing device according to another preferred embodiment of the present invention.

Referring to FIG. 2, the substrate processing device 100 may include the first mask 110, the second mask 120, the first squeeze 130, a second squeeze 140, the first heating means 150, and a second heating means 160.

The substrate processing device 100 according to another preferred embodiment of the present invention is a device for applying a flux and a solder to form the bump on the base substrate.

When the flux ball is mounted on the base substrate, the first mask 110 may be disposed on the base substrate. The base substrate may include the connection pad. The connection pad is the region in which the bump is formed later and may be mounted with the flux ball. The flux ball may be in a solid state. For example, the flux ball may be a spherical solid particle made of a flux. Further, the flux ball may be formed including at least one of rosin, resin, a thinner, and an activator. The first mask 110 may be provided with the first opening through which the connection pad mounted with the flux ball is exposed. That is, the flux ball may be disposed on the connection pad through the first opening of the first mask 110.

When the solder ball is mounted on the connection pad, the second mask 120 may be disposed on the base substrate. In this case, the connection pad may be in a state in which the flux is applied by the flux ball. The second mask 120 may be provided with a second opening through which the connection pattern mounted with the solder ball is exposed. That is, the solder ball may be disposed on the connection pad through the second opening of the second mask 120.

According to the preferred embodiment of the present invention, the first mask for mounting the flux ball and the second mask for mounting the solder ball are individually divided, but the preferred embodiment of the present invention is not limited thereto. That is, the first mask 110 and the second mask 120 are the same, and therefore may be used when the flux ball is mounted and when the solder ball is mounted.

The first squeeze 130 may insert the flux ball into the first opening of the first mask 110. The first squeeze 130 squeezes at least one flux ball over the first mask 110 to insert each of the flux balls into the first opening. As such, the flux ball is inserted into the first opening and thus may be disposed on the connection pad of the base substrate. The first squeeze 130 may be made of materials, such as metal and rubber.

The second squeeze 140 may insert the solder ball into the second opening of the second mask 120. The second squeeze 140 squeezes at least one solder ball over the second mask 120 to be inserted into the second opening of the second mask 120. As such, the solder ball is inserted into the second opening and thus may be disposed on the connection pad of the base substrate. Herein, the plurality of solder balls may be formed to have the same size. Therefore, the number of solder balls mounted on each of the connection pads may be the same. In this case, the connection pad of the base substrate may be applied with the flux.

The preferred embodiment of the present invention describes using different squeezes when the flux ball and the solder ball are mounted on the base substrate, but is not limited thereto. That is, the flux ball and the solder ball may be mounted on the base substrate by the same squeeze.

The first heating means 150 may heat the flux ball. The first heating means 150 may include at least one heater. Further, the first heating means 150 may include at least one hot air blower.

The second heating means 160 may heat the solder ball. The second heating means 160 may include at least one heater. Further, the second heating means 160 may include at least one hot air blower.

Although not illustrated in the preferred embodiment of the present invention, the substrate processing device 100 may further include the flux ball pick-up means (not illustrated) individually mounting the flux balls on the connection pad on which the flux ball is not mounted after the flux ball is squeezed by the first squeeze 130. Similarly, the substrate processing device 100 may further include the solder ball pick-up means (not illustrated) individually mounting the solder ball on the connection pad on which the solder ball is not mounted after the solder ball is squeezed by the second squeeze 140. Further, the flux ball pick-up means (not illustrated) and the solder ball pick-up means (not illustrated) may be the same means.

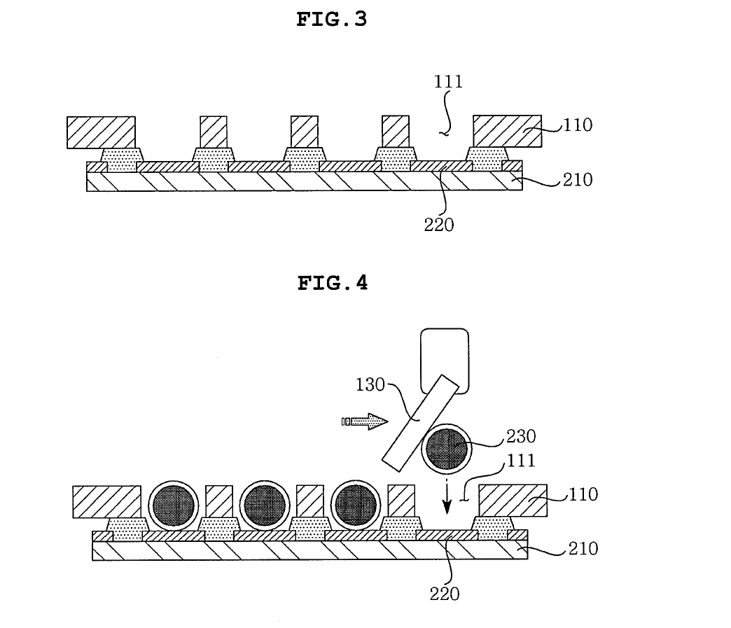

FIGS. 3 to 10 are exemplified diagrams illustrating a method of manufacturing a substrate according to another preferred embodiment of the present invention.

The method of manufacturing a substrate of FIGS. 3 to 10 may be performed by the substrate processing device 100 (FIG. 2) illustrated in FIG. 2.

Referring to FIG. 3, the first mask 110 may be disposed over a base substrate 210. The base substrate 210 may be generally made of a composite polymer resin which is used an interlayer insulating material. A connection pad 220 may be formed on the base substrate 210. The connection pad 220 may be a component which electrically connects external components to the base substrate 210. The connection pad 220 may be made of an electro-conductive material. The base substrate 210 on which the connection pad 220 according to the preferred embodiment of the present invention is disposed may be generally a printed circuit board. The printed circuit board is formed in a single layer, but although not illustrated, may be provided with a build-up layer which includes a multi-layer insulating layer, a circuit layer, and a via.

The first mask 110 may be disposed over the base substrate 210. The first mask 110 may be provided with the first opening 111. The first opening 111 may be disposed at a position corresponding to the connection pad 220 of the base substrate 210. That is, when the first mask 110 is formed over the base substrate 210, an upper portion of the connection pad 220 is opened by the first opening 111 and thus may be exposed. The first mask 110 according to the preferred embodiment of the present invention may be a metal mask made of metal.

Referring to FIG. 4, a flux ball 230 may be mounted on the base substrate 210. The flux ball 230 may be in a solid state. For example, the flux ball 230 may be a spherical solid particle made of a flux. The flux ball 230 may be mounted on the base substrate 210 by the first squeeze 130. The first squeeze 130 may squeeze the plurality of flux balls 230 over the first mask 110 formed on the base substrate 210. The flux ball 230 may be inserted into the first opening 111 of the first mask 110 by the squeezing of the first squeeze 130. Therefore, the flux balls 230 may be mounted on the each of the connection pads 220 through the first opening 111. In this case, the number of flux balls 230 mounted on each of the connection pads 220 may be the same by controlling a diameter or a volume of the flux ball 230. For example, when a central diameter of the flux ball 230 is the same as or similar to the diameter of the first opening 111, one flux ball 230 may be mounted on each of the connection pads 220. The first squeeze 130 according to the preferred embodiment of the present invention may be made of a metal or rubber material.

Although not illustrated in the preferred embodiment of the present invention, after the flux ball 230 is squeezed by the first squeeze 130, the connection pad 220 on which the flux ball 230 is not mounted may be present. In this case, each of the connection pads 220 on which the flux balls 230 are not mounted may be individually mounted with the flux balls 230.

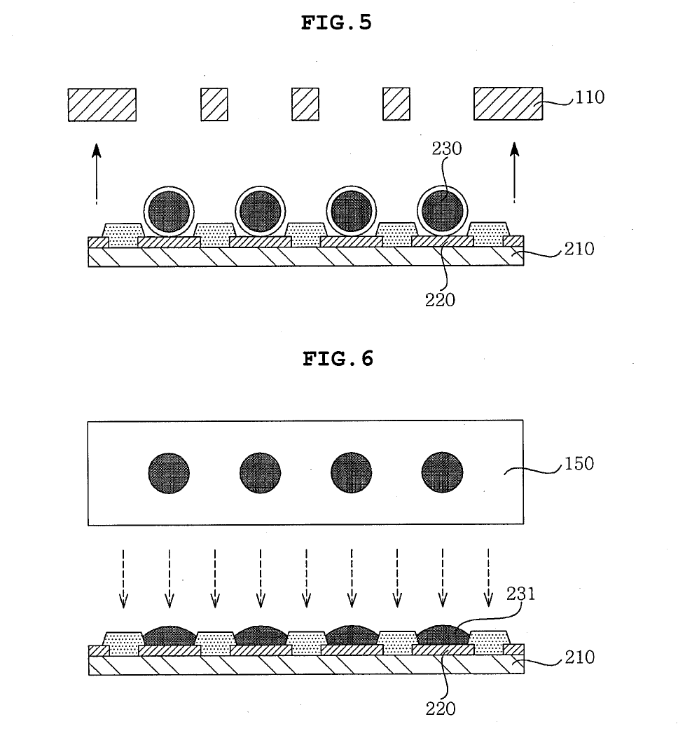

Referring to FIG. 5, the first mask 110 may be removed. The base substrate 210 is mounted with the flux ball 230 and then the first mask 110 may be removed.

Referring to FIG. 6, the flux ball 230 may be heated, The flux ball 230 (FIG. 5) mounted on the base substrate 210 may be heated by the first heating means 150. In this case, the first heating means 150 may be at least one heater or a hot air blower. The flux ball 230 (FIG. 5) may be heated and melted by the first heating means 150. The flux ball 230 (FIG. 5) is melted and thus a flux 231 may be applied on the connection pad 220. In this case, the same flux balls 230 (FIG. 5) are mounted on each of the connection pads 220, such that the amount of fluxes 231 applied on each of the connection pads 220 may be the same. As such, defects, such as flux short, may be prevented by controlling the amount of fluxes 231 applied on the connection pad 220 by the flux ball 230 (FIG. 5).

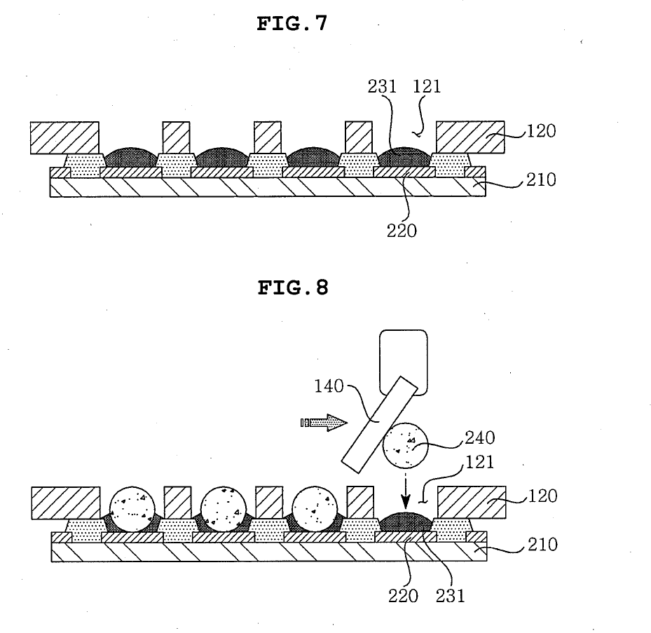

Referring to FIG. 7, the second mask 120 may be disposed over the base substrate 210. The second mask 120 may be provided with the second opening 121. The second opening 121 may be disposed at a position corresponding to the connection pad 220 of the base substrate 210. That is, when the second mask 120 is disposed over the base substrate 210, the flux applied on the connection pad 220 may be exposed by the second opening 121. The second mask 120 may be made of a metal material.

The preferred embodiment of the present invention individually uses the first mask 110

(FIG. 3) and the second mask 120, but is not limited thereto. For example, the first mask 110 (FIG. 3) and the second mask 120 may be the same.

Referring to FIG. 8, a solder ball 240 may be disposed on the base substrate 210. The solder ball 240 may be mounted on the base substrate 210 by the second squeeze 140. The second squeeze 140 may squeeze the plurality of solder balls 240 over the second mask 120 formed on the base substrate 210. Herein, the plurality of solder balls 240 may be formed to have the same size as each other. Therefore, the number of solder balls 240 mounted on each of the connection pads 220 may be the same. The solder ball 240 may be inserted into the second opening 121 of the second mask 120 by the second squeeze 140. Therefore, the solder balls 240 may be mounted on each of the connection pads 220 through the second opening 121. In this case, the connection pad 220 is applied with the flux 231 and thus the solder ball 240 may be disposed on the flux 231. The second squeeze 140 may be made of a metal or rubber material. Although not illustrated in the preferred embodiment of the present invention, after the solder ball 240 is squeezed by the second squeeze 140, the connection pad 220 on which the solder ball 240 is not mounted may be present. In this case, each of the connection pads 220 on which the solder balls 240 are not mounted may be individually mounted with the solder balls 240.

The preferred embodiment of the present invention individually uses the first squeeze 130 (FIG. 4) and the second squeeze 130, but is not limited thereto. For example, the first squeeze 130 (FIG. 4) and the second squeeze 140 may be the same.

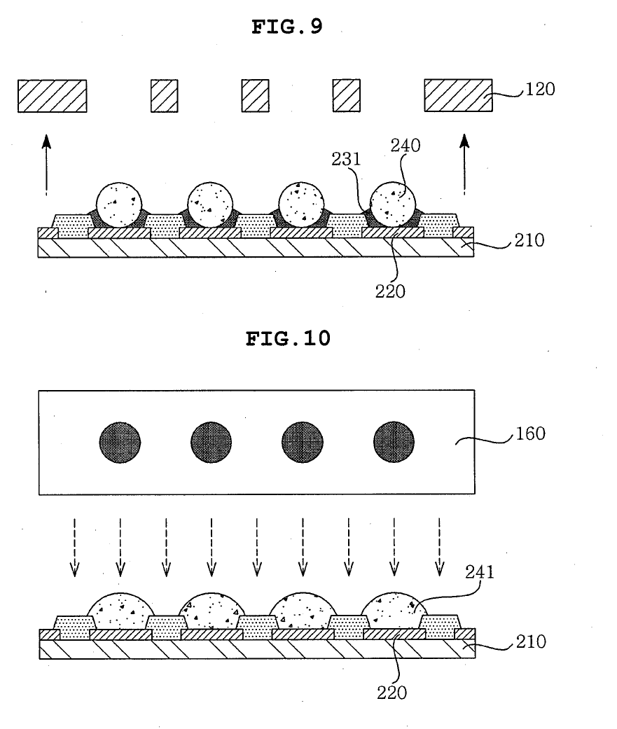

Referring to FIG. 9, the second mask 120 may be removed. After the solder ball 240 is mounted on the base substrate 210, the second mask 120 may be removed.

Referring to FIG. 10, the solder ball 240 may be heated. The solder ball 240 (FIG. 9) mounted on the base substrate 210 may be heated by the second heating means 160. In this case, the second heating means 160 may be at least one heater or the hot air blower. The preferred embodiment of the present invention classifies the first heat means 150 (FIG. 6) and the second heating means 160 as the individual device, but is not limited thereto. That is, the solder ball 240 (FIG. 9) may be heated by using the first heating means 150 (FIG. 6) for heating the flux ball 230 (FIG. 6).

The solder ball 240 (FIG. 9) is melted by the second heating means 160 and thus may be the bump 241. The amount of flux 231 (FIG. 9) and the amount of solder ball 240 (FIG. 9) which are applied on the each of the connection pads 220 are the same, and therefore the volumes of each of the bumps 241 may be the same. As described above, the bump 241 is formed by using a solid type of flux ball 230 (FIG. 5) and the solder ball 240 (FIG. 9), thereby easily controlling the volume of the bump 241. Therefore, it is possible to prevent the short from occurring between the bumps 241.

As described above, after the bump 241 is formed on the base substrate 210, the flux 231 (FIG. 9) remaining on the connection pad 220 may be removed.

The preferred embodiment of the present invention individually use the first heating means 150 (FIG. 6) and the second heating means 160, but is not limited thereto. For example, the first heating means 150 (FIG. 6) and the second heating means 160 may be the same.

According to the substrate processing device and the method of manufacturing a substrate according to the preferred embodiments of the present invention, the single spherical flux ball and solder ball may be mounted on the single connection pad. As described above, the flux ball is mounted on the connection pad and then the flux ball is heated, thereby applying the flux on the connection pad. In this case, since one flux ball is mounted on each of the connection pads, the same amount of flux may be applied on all the connection pads. Further, when the same amount of flux is applied on the plurality of connection pads, the volumes of each of the bumps formed by using the solder ball may be the same. Further, the substrate processing device according to the preferred embodiment of the present invention forms the flux ball and the solder ball by using the same squeeze and mask, thereby reducing the process cost.

According to the substrate processing device and the method of manufacturing the same according to the preferred embodiments of the present invention, it is possible to prevent the flux short or the bump short.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A substrate processing device, comprising:
a first mask disposed over a base substrate and provided with a first opening which exposes a connection pad of the base substrate;
a fust squeeze inserting a flux ball into a first opening of the first mask; and
a first heating means heating a flux ball which is disposed on the connection pad.

2. The substrate processing device as set forth in claim 1, wherein the flux ball is in a solid state.

3. The substrate processing device as set forth in claim 1, wherein the first mask is a metal mask.

4. The substrate processing device as set forth in claim 1, further comprising:
a second mask provided with a second opening disposed at a position corresponding to an upper portion of the connection pad.

5. The substrate processing device as set forth in claim 4, wherein a solder ball is inserted into the second opening of the second mask.

6. The substrate processing device as set forth in claim 5, further comprising:
a second squeeze inserting the solder ball into the second opening of the second mask.

7. The substrate processing device as set forth in claim 5, further comprising:
a second heating means heating the solder ball.

8. A method of manufacturing a substrate, comprising:
preparing a base substrate provided with a connection pad;
forming a first mask including a first opening exposing the connection pad over the base substrate;
inserting the flux ball into the first opening of the first mask; and
heating the flux ball.

9. The method as set forth in claim 8, wherein the flux ball is in a solid state.

10. The method as set forth in claim 8, wherein the fust mask is a metal mask.

11. The method as set forth in claim 8, wherein in the inserting of the flux ball into the first opening of the first mask, the flux ball is inserted into the first opening by using a first squeeze.

12. The method as set forth in claim 8, further comprising:
after the inserting of the flux ball into the first opening of the first mask, removing the first mask.

13. The method as set forth in claim 8, further comprising:
after the heating of the flux ball, disposing the solder ball over the heated flux ball.

14. The method as set forth in claim 13, wherein the disposing of the solder ball includes:
forming a second mask, which is provided with the second opening disposed at a position corresponding to an upper portion of the connection pad, over the base substrate; and
inserting the solder ball into the second opening of the second mask.

15. The method as set forth in claim 14, wherein in the inserting of the solder ball into the second opening of the second mask, the solder ball is inserted into the second opening by using a second squeeze.

16. The method as set forth in claim 14, further comprising:
after the inserting of the solder ball into the second opening of the second mask, removing the second mask.

17. The method as set forth in claim 14, further comprising:
after the inserting of the solder ball into the second opening of the second mask, heating the solder ball to form a bump.

18. The method as set forth in claim 17, further comprising:
after the forming of the bump, removing a flux remaining on the base substrate.
